(19) United States
(12) Patent Application Publication
(10) Pub. No.: US 2025/0229791 A1
(43) Pub. Date: Jul. 17, 2025

(54) INSTANTANEOUS TIRE TRACTION MODULATING VALVE

(71) Applicant: PRASAD MUTHUKUMAR

(72) Inventor: PRASAD MUTHUKUMAR

(21) Appl. No.: 19/103,481

(22) PCT Filed: Aug. 30, 2023
(86) PCT No.: PCT/IN2023/000009

§ 371 Date: Feb. 12, 2025

(30) Foreign Application Priority Data
Sep. 1, 2022 (IN) 202241010899

(51) Int. Cl. B60W 50/00; B60C 23/00; B60C 29/00; B60R 16/033; B60W 30/02; G07C 5/02

(52) U.S. Cl. CPC B60W 50/0098; B60C 23/001; B60C 29/002; B60W 30/02; B60R 16/033; B60W 2530/20; G07C 5/02

(57) ABSTRACT

Instantaneous Tire Traction Modulating Valves [ITTMV] is a wheels internal and external highly time-sensitive application specific fail-safe electro-pneumatic valve design, valve's current-profile and regulator technique that proactively sense and instantaneously modulate the tire pressure between tire's upper and lower cut-off pressure valves from present/recommended values particularly during imminent/inevitable critical driving situations to mitigating-aquaplaning/hydroplaning, loss of stability/control, over/under steering, loss-of-traction, minimise-emergency/high speed braking distance, roll-over and loss of control due to puncture; by real-time sensing, perform context-aware computing and directing Tyre Pressure Modulating Units [TPMU] to actively modulate the tyre pressure in right time with right pressure on right tyres thereby instantly optimizing footprint/sidewall deformation rate to enhance tire traction simultaneously sustaining stability/steer-ability and restore/optimize to pre-set tyre pressure value immediately after overcoming critical situation for further safe and comfortable driving. Wheel hub housing integrated with rotary-link comprising electrically-insulated conductive-fluidic containers to transfer ITTMV's operational power and control-signal/data to wheels.

### FIELD OF INVENTION

The Instantaneous Tire Traction Modulating Valves [ITTMV] is related to automobile or transportation domain and more particularly into vehicles utilising pneumatic tires.

### OBJECTIVE OF INVENTION

Objective of the invention is to enhance vehicle traction and stability in critical driving situations like hydroplaning, avoid or mitigate—loss of traction, roll over or loss of stability, emergency braking distance, inevitable collision, puncture, over and under steering through instantaneously modulating tyre pressure ultimately to protect the vehicle, occupants, pedestrians and other things around or on the way by preventing or reducing the impact of collision.

### BACKGROUND OF INVENTION

Tyre pressure plays an important role in vehicle traction and stability. There are some tyre pressure control systems that only works to maintain optimum or set tyre pressure value throughout the period of time (that won't change according to critical situations) which only helps to enhance driving on various terrains and won't sense critical situations or instantly vary or control the maintained tyre pressure thereby to aid the vehicle to overcome the critical situations like—emergency braking, hydroplaning, loss of traction, loss of stability or roll over mitigation, over and under steering mitigation etcetera. There are scenarios where the fixed optimum and pre-set terrain based tyre pressure control system (used enhancing driving in various terrains which maintain constant pressure irrespective of critical situation like hydroplaning) that won't help in mitigating hydroplaning. During emergency braking the tyre traction can also vary based on contamination between tyres and road surfaces (contact area) like layer of water, sand etcetera which can causes significant loss of traction and the tyre pressure control system won't works in sensing and mitigating these scenarios. More particularly the slow processing and functioning speed of the other Tyre Pressure Control Systems (TPCS) won't work or help in critical situations as these scenarios are highly time sensitive that requires instant processing and functioning. Also other systems that utilise vehicles with integrated or inbuilt compressor and similar systems have lot of complications as it consumes the valuable space and power also adding extra weight to the vehicle which making more expensive, complex to—operate, integrate, maintain and service that prevents it from large-scale implementation.

### SUMMARY

To address the issues with optimally maintaining tyre pressure constantly all over the time and other non-time sensitive tyre pressure control systems, the ITTMV provides a Instantaneous Tire Traction Modulating Valves [ITTMV] that instantaneously works in critical situations by sensing, computing and controlling the tyre pressure on right tyres with right pressure in right time according to critical situations thereby to enhance the available traction and stability. The ITTMV aids in enhancing and effectively optimizing vehicles overall performance in safety, stability, control, speed, mileage, reducing tyre wear & tear and impact on environment. The critical situations won't occur always but can occur at any time as a surprise and the ITTMV constantly monitors and equipped to face the challenges placed ahead thereby helps in overcoming or mitigating the critical driving situation ultimately protecting the passengers, pedestrians, vehicles and other objects in and around the way. Even an inch to a meter distance is crucial in extreme situations to avoid, mitigate and reduce the impact of collision that in turn helps in saving valuable lives and property. The ITTMV 102 performs active sensing, pre-computing & set ready to control the tyre pressure prior to critical situation, current-computing for controlling the tyre pressure during critical situation, post-computing to optimize tyre pressure after overcoming the critical situation ultimately to overcome and mitigate the critical situations. The ITTMV mainly controls the tyre pressure between upper and lower cut-off tyre pressure values with corresponding change in vehicles load and centre of gravity thereby mitigating critical situations simultaneously preventing over and under inflation ultimately to sustain stability. ITTMV utilise smart and adaptive closed loop processing algorithm with predetermined and tested lookup table to instantaneously check and compare the effects between predetermined and tested real world scenarios to the actual real world scenarios for actively sensing, computing and controlling the tyre pressure in right time on right tyres with right pressure thereby to mitigate the critical situations. Since various parameters and multiple critical situations are simultaneously taken into account by ITTMV for computation, the ITTMV's algorithm smartly sense, prioritise & balance between to achieve an optimized solution. The ITTMV works in standalone mode based on sensor system parameters or in addition interoperate with vehicles safety and stability systems to further enhance the efficiency of ABS, EBD, ESC, TCS, BA, suspension system, roll over mitigation system, automotive aerodynamics & airbrakes etcetera thereby enhancing the overall performance in sustaining traction and stability. As most of the parameters utilised by ITTMV are already available with vehicles; which in turn aids in easy implementation of ITTMV. ITTMV in addition to instantaneously varying and controlling the tyre pressure in critical situations also immediately optimizes or restores the tyre pressure if difference or variation in tyres pressure is detected from the optimum or pre-set pressure value once the vehicle overcomes the critical situations to continue with safe & comfortable driving with enhanced stability, mileage and to reduce tyre noise. According to design, configuration and scenarios the ITTMV either controls the pressure by releasing the fillers to atmosphere while maintaining the tyres lower cut off threshold pressure value to sustain stability and instantaneously optimize the pressure on all tyres for further safe driving (till next gas station or filling) until restoration or else restores the pressure to optimum pre-set value utilising in inbuilt reservoir or other external restoration systems immediately after the vehicle overcomes critical situation to continue with comfortable driving. Either dedicated hard or soft or its combinations ITTMV switches are utilised for manually activate ITTMV. The following aspects are flexible as either basic to higher end, one or multiple or combination of following aspects are utilised according to design, configurations, requirements and scenarios.

According to another aspect the ITTMV instantaneously mitigates hydroplaning or aquaplaning by actively sensing, computing and controlling (increasing) the tyre pressure on right tyres with right pressure on right time while maintaining the tyres upper cut-off threshold value to reduce the surface area of tyre to avoid water deflected inwards, increasing the tyres grooves & thread depth to deflect more water outward thereby helping in clearing water which in turn prevents the rising of tyres thereby to restoring traction and mitigating aquaplaning.

According to another aspect, the ITTMV actively sense the critical situation like low or loss of traction, stability etcetera in snow or Icy road surface thereby instantaneously modulate the tire pressure to engage and extend the studs to provide enhanced traction.

According to another aspect the physical constructional features of ITTMV comprises of electro pneumatic valve with at least one dedicated outlet both internally and externally in the valve stem with always open internal outlet and normally closed external governor valve controlled outlet connected with armature and solenoid for actively controlling the tire pressure and a fixed valve on the top for normal restoration of tire pressure.

According to another aspect the ITTMV instantaneously mitigates the extreme loss of traction, skid and wheels spin on either one or multiple wheel tyres by actively sensing, computing and controlling the tyre pressure between or corresponding tyres in right time with right pressure thereby to restore and mitigate loss of traction.

According to another aspect, the ITTMV instantaneously works to mitigate over and under steering by actively sensing, computing and controlling the tyre pressure in right time with right pressure on right tyres thereby controlling thread depth, enhancing traction, controlling contact patch or foot print, controlling tyres cornering stiffness and controlling tyre deformation thereby mitigating positive and negative gradient to sustain zero or neutral gradient.

According to another aspect, the ITTMV instantaneously mitigate roll over and loss of stability by actively sensing the vehicle (moving with hard cornering and in surface like highly uneven, inclined, slope etcetera) that tend to move beyond available stability systems limits and centre of gravity [load] thereby computing and controlling the tyre pressure in right time with right pressure on right tyres thereby to sustain stability.

According to another aspect, the ITTMV mitigates the loss of control & stability in puncture scenario (besides alerting the driver regarding rapid loss of pressure in puncture scenarios) by actively sensing and instantaneously supplying the fillers [air or nitrogen] from the reservoir to the punctured tyres thereby to sustain the pressure preventing the rapid loss of tyre pressure ultimately improving the time of drivability and stability of the vehicle.

According to another aspect, the ITTMV instantaneously works to enhance extreme and high speed-cornering (hard cornering) performance, torque vectoring and handling characteristic by instantaneously sensing, computing and controlling the tyre pressure in right time with right pressure on right tyres thereby assist in sharp cornering, preventing tyres sidewall deformation simultaneously optimizing traction and stability.

According to another aspect, the ITTMV particularly utilises one or more high pressure reservoirs or tanks for storing the fillers like air and nitrogen that are optimally located (mounted) or integrated on wheel's rim, spoke's, hub, axle etcetera with pneumatic valve and control system for controlling the tyre pressure in critical situations and optimizing or restoring the tyre pressure during and after overcoming the critical situations according to the modulating signal from ITTMV. These reservoir systems operates without any compressor or similar sources as the pressure maintained in the reservoir is higher (multiple times) than the optimum tyre pressure for the fluids or fillers to flow from reservoir to tyre thereby controlling the tyre pressure accordingly and the fillers are restored through external sources.

### BRIEF DESCRIPTION OF THE DIAGRAM:

To get a comprehensive understanding of the ITTMV, diagrams are described by examples.

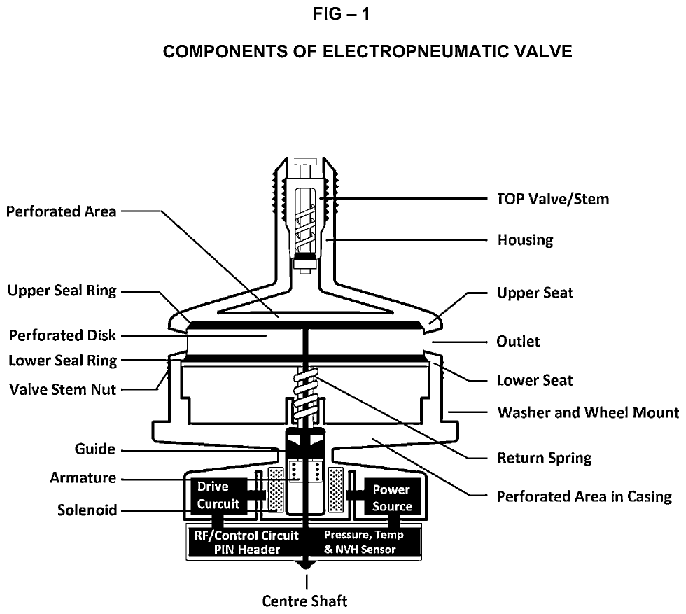

FIG. 1 ILLUSTRATES PHYSICAL CONSTRUCTIONAL FEATURES AND COMPONENTS OF INSTANTANEOUS TIRE TRACTION MODULATING VALVE

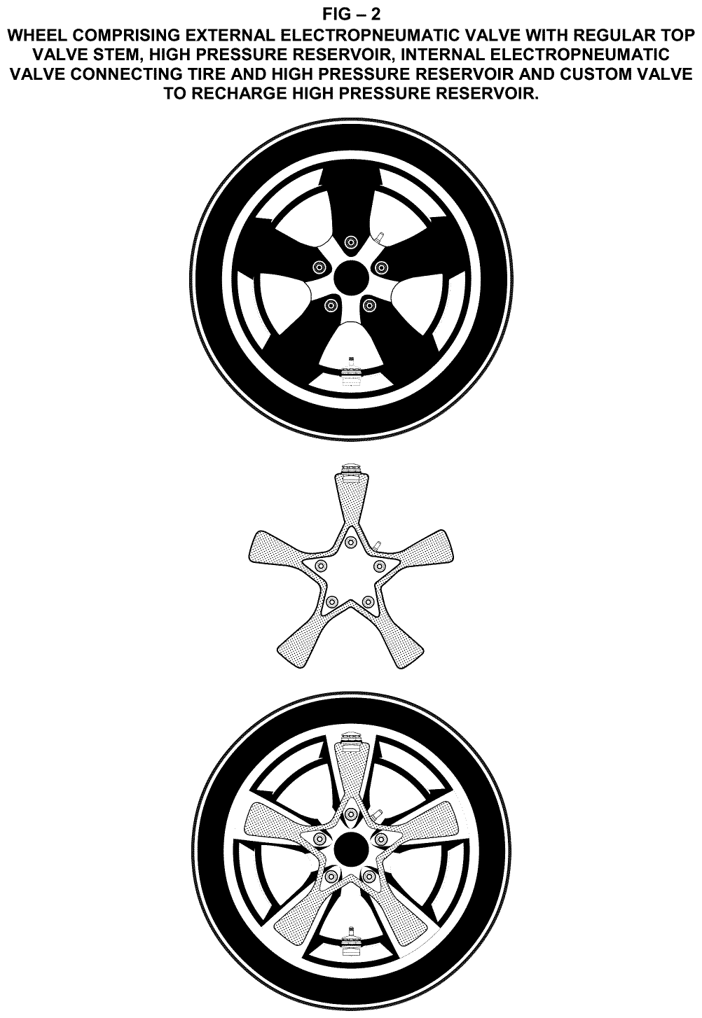

FIG. 2 ILLUSTRATES WHEEL COMPRISING EXTERNAL ELECTROPNEUMATIC VALVE WITH REGULAR TOP VALVE STEM, HIGH PRESSURE RESERVOIR, INTERNAL ELECTROPNEUMATIC VALVE CONNECTING TIRE AND HIGH PRESSURE RESERVOIR AND CUSTOM VALVE TO RECHARGE HIGH PRESSURE RESERVOIR.

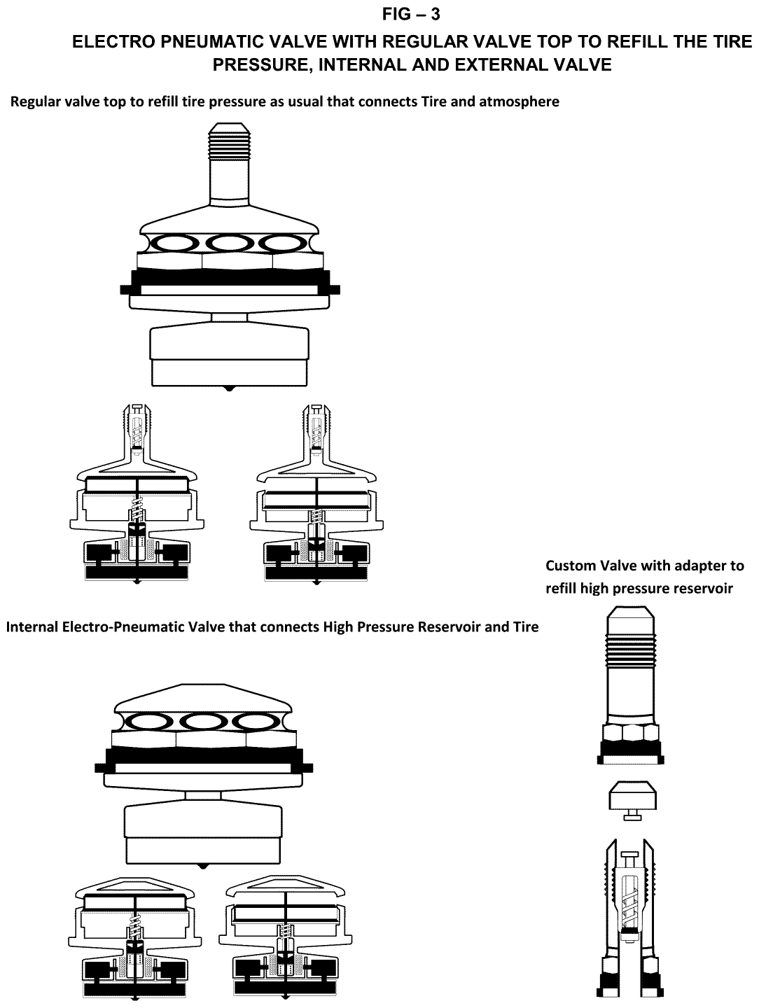

FIG. 3 ILLUSTRATES ELECTRO PNEUMATIC VALVE WITH REGULAR VALVE TOP TO REFILL THE TIRE PRESSURE, INTERNAL AND EXTERNAL VALVE

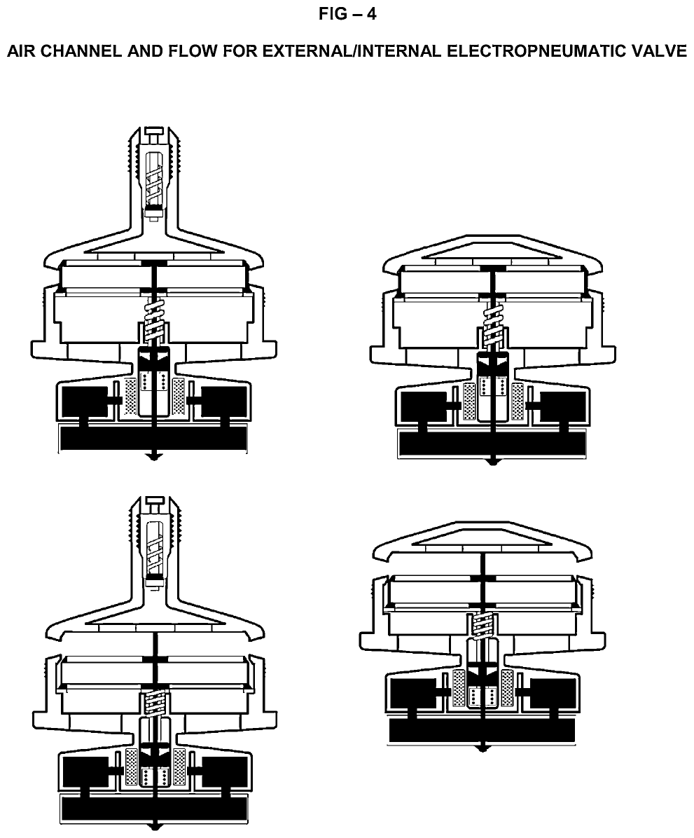

FIG. 4 AIR CHANNEL AND FLOW FOR EXTERNAL/INTERNAL ELECTROPNEUMATIC VALVE

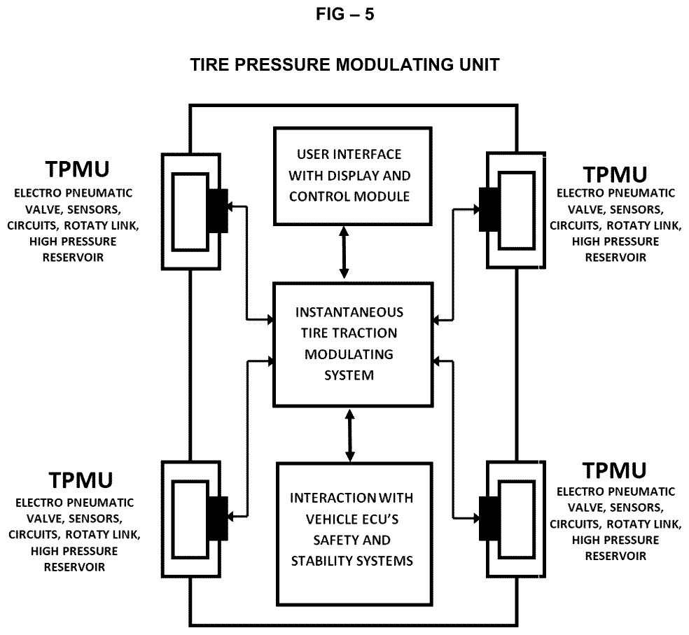

FIG. 5 ILLUSTRATES THE BLOCK DIAGRAM OF ITTMV COMPRISING OF COMPONENTS ACCORDING TO INSTANTANEOUS TIRE TRACTION MODULATING VALVES [ITTMV] (ITTMV), TYRE PRESSURE MODULATING UNIT (TPMU), USER INTERFACE, INTERACTION WITH OTHER SENSOR SYSTEMS, ECU, SAFETY AND STABILITY SYSTEMS

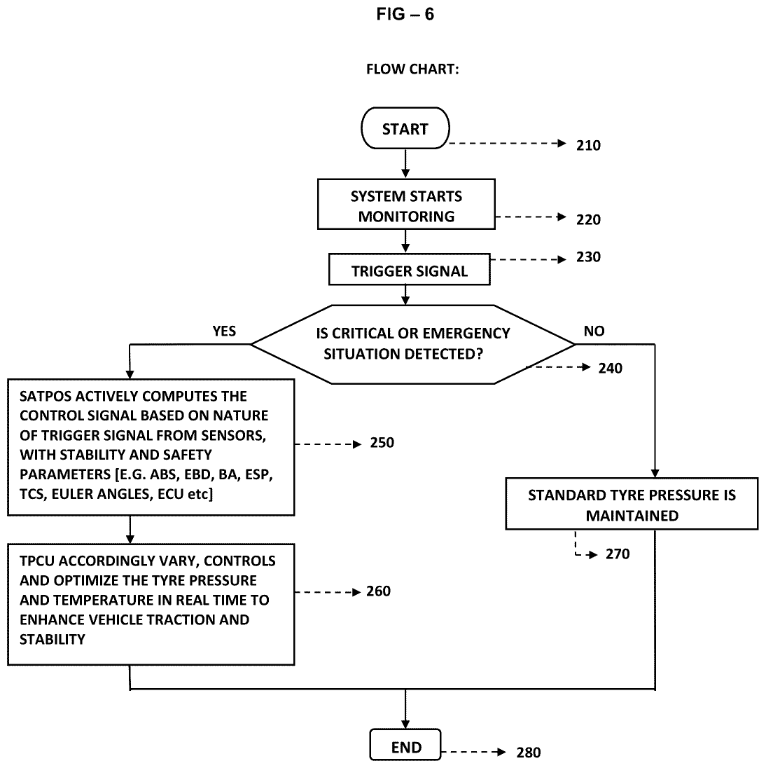

FIG. 6 ILLUSTRATES THE FLOWCHART AND DESCRIBES THE METHOD OF OPERATION OF THE INSTANTANEOUS TIRE TRACTION MODULATING VALVES [ITTMV].

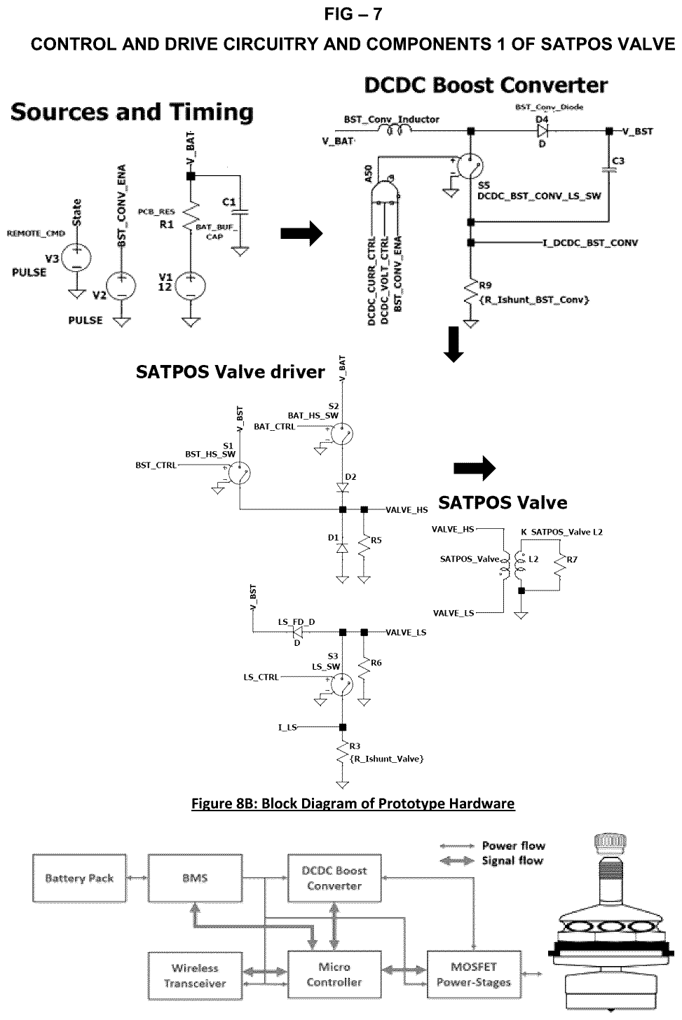

FIG. 7 ILLUSTRATES CONTROL AND DRIVE CIRCUITRY AND COMPONENTS 1 OF SATPOS VALVE

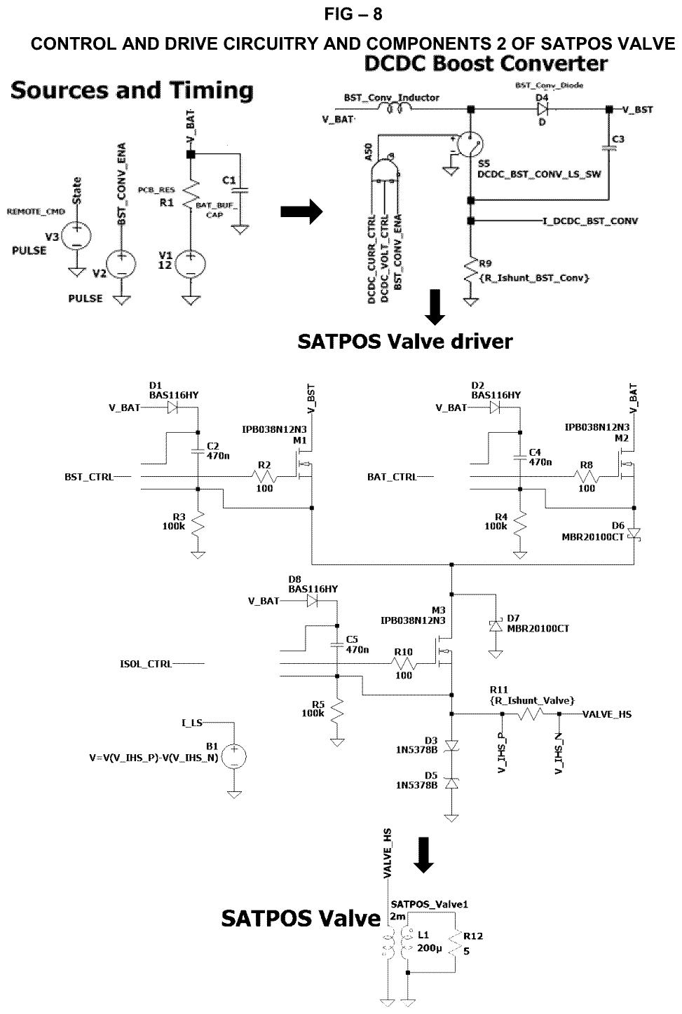

FIG. 8 ILLUSTRATES CONTROL AND DRIVE CIRCUITRY AND COMPONENTS 2 OF SATPOS VALVE

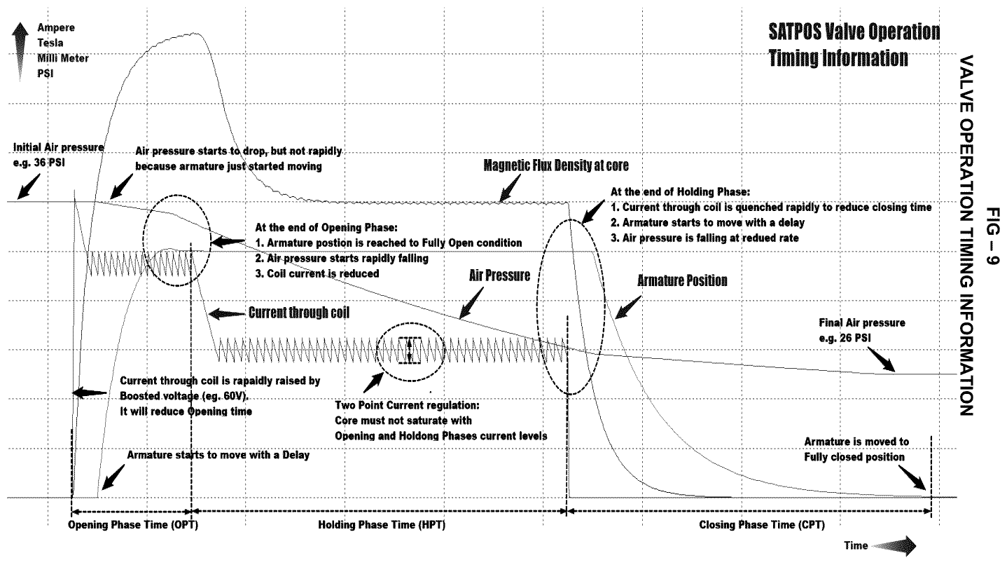

FIG. 9 ILLUSTRATES VALVE GRAPHICAL OPERATION TIMING INFORMATION

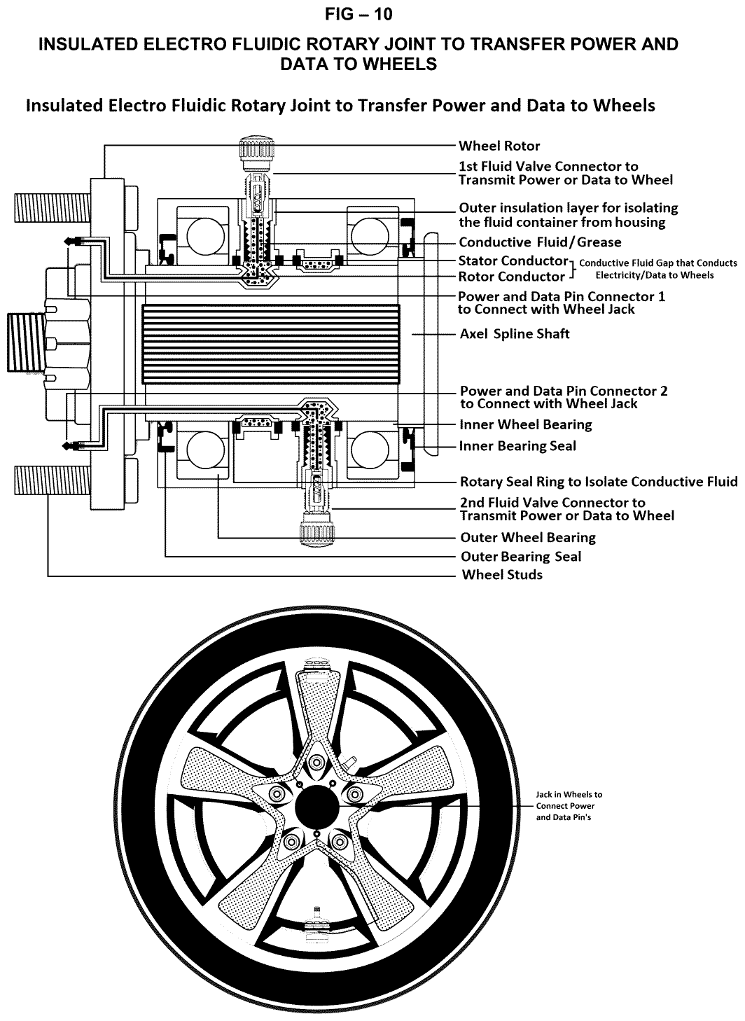

FIG. 10 ILLUSTRATES INSULATED ELECTRO FLUIDIC ROTARY JOINT TO TRANSFER POWER AND DATA TO WHEELS

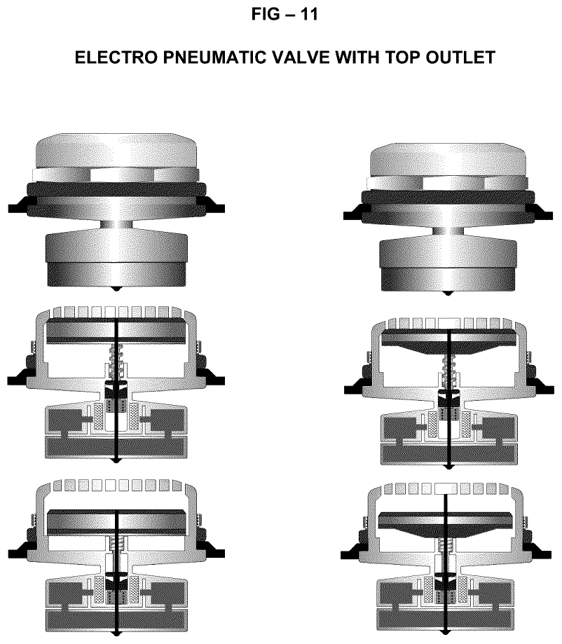

FIG. 11 ILLUSTRATES ELECTRO PNEUMATIC VALVE WITH TOP OUTLET

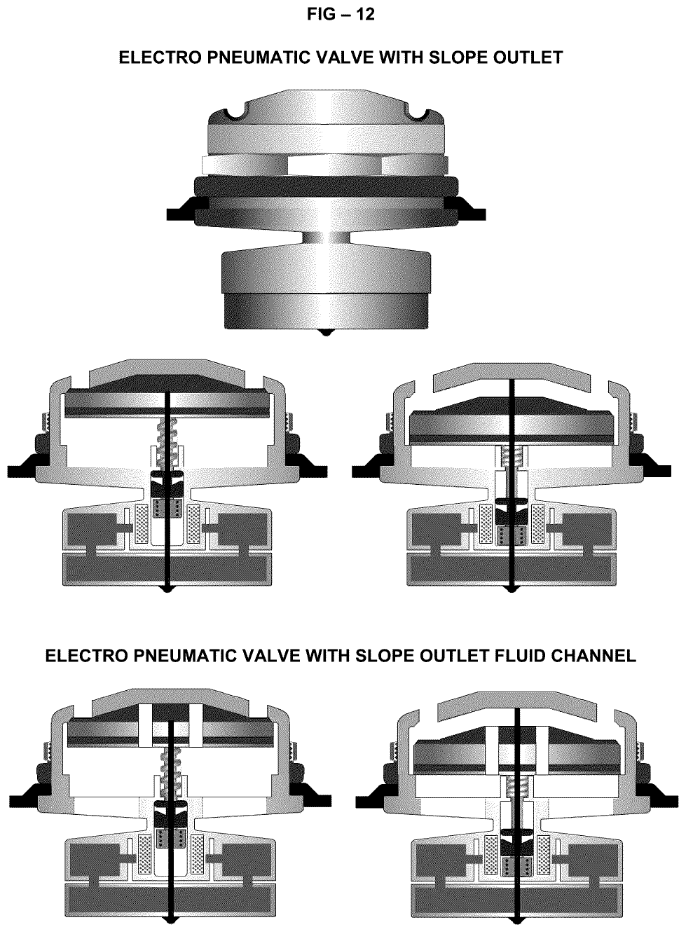

FIG. 12 ILLUSTRATES ELECTRO PNEUMATIC VALVE WITH SLOPE OUTLET

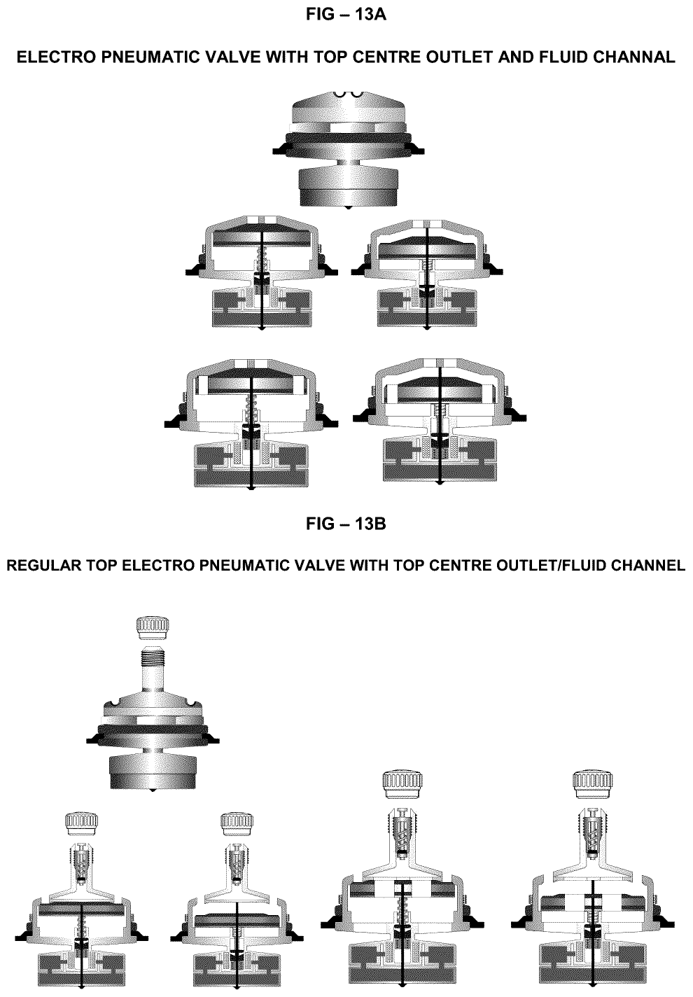

FIG. 13A ILLUSTRATES ELECTRO PNEUMATIC VALVE WITH TOP CENTRE OUTLET AND FLUID CHANNEL

FIG. 13B ILLUSTRATES REGULAR TOP ELECTRO PNEUMATIC VALVE WITH TOP CENTRE OUTLET/FLUID CHANNEL

### DETAIL DESCRIPTION

FIG. 2 illustrates the Hardware, Functionality, Feasibility, Interoperability, Compatibility and Adaptability of the ITTMV with Vehicles Existing systems for Immediate Implementation.
a) Electro Pneumatic Valve Core—Existing valve stem with electro pneumatic valve core is coupled with solenoid actuated system and are utilised by the ITTMV system for actively opening and closing the valve during critical situations.
b) Power Source—Existing Tire Pressure Monitoring System (TPMS) power source is enhanced and utilised for ITTMV operations.
c) Circuitry—Existing TPMS circuitry is enhanced and utilised for the ITTMV operations.
d) Communication System—Existing TPMS communication system architecture is enhanced and are utilised by ITTMV system for its own signalling and operation.
e) On Board Computer and Processing unit—Vehicle's existing on-board computer is utilised by the ITTMV for actively collecting the required parameters, centralised processing and instantaneously directing the TPMU's on each wheel tires to control the tire pressure in critical situations.

Figures describe the physical constructional features, working and fluid flow channels of the application specific electro pneumatic valve. The electro pneumatic valve comprises Valve Stem Cap, Valve Stem, Valve Core, Valve Stem Nut with [With Pressed in Washer], Rubber Grommet Seal, Wheel mount. Centre Shaft, Plunger [Top Dead Centre and Bottom Dear Centre], Return Spring, Solenoid, Armature, Outlet, Upper Seat, Lower Seat, Upper seal Ring, Lower Seal Ring, Perforated Disk, Release Opening, Plunger [Top Dead Centre and Bottom Dear Centre], Stem that connects the armature, disk, guide, Stem that connects the armature and disk. Also to avoid mistaken refilling of higher tire pressure on normal tires the high pressure reservoir comprise of a custom valve stem that needs a special adapter to fill the higher tire pressure. The diagrams describe various configurations, working principles, fluid channels and physical constructional features of the electro pneumatic valve and custom valves in tandem with high pressure reservoir. The solenoid and armature are individually, sequentially or simultaneously energised to optimize the opening time according to design, configuration and scenarios.

FIGS. 7, 8 & 9—The electrical and electronic circuitry of the system may comprises of power source, timing unit, DCDC boost convertor, valve drive and valve coil. This component will be mounted on the revolving wheels. In prototype these valves are implemented to instantaneously release the air pressure precisely as per the excitation from “Communication, Control, and Power Electronics”. Opening Phase time (OPT) and closing Phase time (CPT) of the valve must be as less as possible. Holding Phase Time (HPT) of the valve is the time in-between OPT and CPT during which valve will be maintained at completely open position. To start with, we will consider the Opening Time (OPT) as 50 mS and Closing Phase Time (CPT) as 50 mS. The amount of the air released will be controlled by varying Holding Time (HPT) of the valve. Total amount of Air Released will be function of OPT, HPT and CPT.

The ITTMV is a highly flexible design and can be achieved and implemented with simple configuration and can be enhanced and utilized either completely or partly or with minimal modifications on existing design according to requirements and scenarios. For example—One of the highest priority of the ITTMV is reducing the emergency and high speed braking distance in critical situation to protect the vehicles, occupants, pedestrians and other objects around or on the way by actively detecting and instantaneously controlling [reducing] the Tyre pressure in critical situation thereby enhancing tyre traction without losing vehicle's stability and steer-ability ultimately to prevent accident, reduce the impact of collision and severity of accident. This can be achieved without modifying the major components of existing wheel tires design and can be made to work just by integrating or replacing the pneumatic valve stem with electro mechanical [manumatic] pneumatic valve stem. Even the existing pneumatic valve stem design can be utilized by the ITTMV with just modifying and adding control circuitry [with already existing TPMS circuitry] and integrating pneumatic valve control system [like solenoid actuated valve core with existing pneumatic valve stem]. This manumatic like [combination of manual and automatic] pneumatic valves just works like normal valves in non-critical situations supporting manual operations like restoring the pressure, providing least rolling resistance and automatically works only in critical situations to control the tire pressure [Example by reducing the tire pressure up to lower cut-off threshold pressure value] to enhance much needed tire traction thereby actively improving the rolling resistance to reduce the braking distance [particularly without losing the vehicle stability or steer-ability and to continue with further driving even after overcoming the critical situation]. Even in extreme scenarios these electro pneumatic valves operate in fail safe, fail proof and default mode in case of failure to ensure safe operation.

Functionality, Feasibility, Compatibility, Interoperability and Adaptability of the ITTMV with Vehicle's Existing systems: 1. The ITTMV can be made adaptable with most of the already available and existing TPMS by just integrating or replacing existing valve with electro pneumatic valves. The TPMS already comprises power source, circuitry, tire pressure and temperature sensors and the ITTMV can utilize it without the need for dedicated systems. 2. Most of the TPMS systems work utilizing wireless communication. There is no need for dedicated a communication system as the ITTMV can be made to adapt and utilize the already existing Tire Pressure Monitoring System's wireless communication architecture for its own operations. 3. Already available systems like Emergency Brake Assist, ABS, ESP and TCS compromises of sensor system and corresponding computational capability for actively sensing the critical situations and to act accordingly. So no dedicated system is required for sensing the critical situation. 4. The computation is performed by an already available on-board computer just similar to computation of parameters like ABS, EBD, ESP and TCS. The ITTMV computation is performed by vehicles on-board computers within fraction of seconds and there is no need for a dedicated processing unit for the computation and implementation of ITTMV. 5. As the vehicle's on-board computer, safety and stability system's like ABS, EBD, ESP, TCS, Brake Assist (BA), Roll Over Mitigation system already comprises off and accounts most of the parameters sufficient for operation of the ITTMVs like Vehicle and wheel speed, acceleration and deceleration, vehicle orientation and axial rotation, transverse motion and lateral acceleration, load and torque distribution, tyre traction, steering wheel position, cornering effects, change in Centre of gravity, over and under steering, sensing road conditions, suspension and vertical dynamics, puncture detection, radar assisted auto braking, adaptive cruise control system, aerodynamics and airbrakes, there is no need for dedicated systems for sensing and collecting these parameters. The ITTMV just acquires or taps the parameters from vehicle's already available safety and stability system for sensing and computation. 6. The system can be made to inter-operate with vehicle existing safety and stability systems like ABS, EBD, ESP, TCS and BA ultimately further enhancing overall performance of these systems. 7. Particularly this system does not require any Compressor and Fluid Storage System for controlling the tire pressure which in turn aids in completely Saving Mass and Space ultimately reducing the complexity of the system. Highlights—All the following Safety and Stability features can be achieved just by integrating or replacing the present pneumatic valve stem with Electro mechanical pneumatic valve stem.

Interoperations with existing system aids in effortless implementation: Reducing rolling resistance and enhancing tire traction are two different extremes and it is highly difficult to achieve these two simultaneously. But both are extremely important according to scenarios. The rolling resistance is reduced with optimum tire pressure to enhance—mileage, driving dynamics, tire life, to reduce—tire noise, CO2 emission, but these optimum tire pressures and its rolling resistance only sustains corresponding traction which doesn't help in enhancing high speed and emergency braking efficiency. Even ABS, EBD, ESP, BA and TCS are all works only with the available tire traction in critical situations—where in critical situations these system cannot increase the limits of much needed available tire traction and these are only techniques to utilize the available traction efficiently and are only used to decrease the effect of driver's error or to compensate for a driver's inability to react quickly enough to wheel slip, whereas our Active system actually enhances the much needed tire traction in critical situations. As most of the parameters and components utilized by the active system are already available with vehicles; in turn aids in easy implementation of the ITTMV system [just by changing the present pneumatic valve stem to electro pneumatic valves]. The ITTMV takes into account both the extremes and actively provides an optimized solution according to scenarios—with least rolling resistance in non-critical situations and maximum traction in critical situations. Also the ITTMV inter-operates with the existing safety and stability systems like ABS, EBD, ESP, BA and TCS ultimately further enhancing the vehicles overall safety and driving dynamics without compromising—through reduced rolling resistance in normal scenarios and enhanced tire traction in critical scenarios. During the vehicle tire selection process with testing under various conditions where different driving conditions, various loading conditions and even lot of other related parameters are collected and the lower cut-off tire pressure value can calibrated to act accordingly just like calibrating other parameters during testing like ABS, EBD, ESC, TCS and BA

The ITTMV operating area, range or bandwidth are all lies between tire's upper cut-off and lower cut-off threshold pressure values thereby instantaneously controlling or reducing tire pressure up to lower cut-off tire pressure value which is particularly above the minimum tire pressure value [where the opened valve automatically gets closed when lower cut-off pressure is reached] to enhance the much needed traction in critical situations while particularly and simultaneously sustaining stability, steerability and to even drive the vehicle after successfully overcoming the critical situation. Instantaneous Tire Traction Modulating Valves [ITTMV] operate under complete compliance with European Tyre and Rim Technical Organisation (ETRTO), Japan Automobile Tyre Manufacturers Association (JATMA) or Tire and Rim Association US (TRA) Standards.

The TPMU 104 comprises of internal or external power source for its operation and is selected from TPMU's inbuilt batteries, capacitors and vehicle batteries. The power source is wired or wireless and the charging sources for the TPMU's inbuilt battery and capacitor are sourced from vehicle battery, external charging systems, internal self-charging systems with feasible alternator or generator, capacitive coupling, inductive coupling, electromagnetic coupling etcetera. The type of batteries utilised comprise of primary batteries or rechargeable batteries, Regenerative brakes [Kinetic Energy Recovery System or Brake Energy Recuperation System] or its combinations. The power source is internal fixed or replaceable, external and its combinations with ITTMV smartly managing the charging and backup [Example—under & over charging protection] of the power levels with updating & alerting the status of power source to ITTMV, display and user interface. In case on both capacitor and battery utilised, according design configuration and scenarios ITTMV utilise the battery to power the monitoring system for sensing and updating the status of tyre pressure, temperature, RF transmission etcetera and the capacitor can be utilised to instantaneously supply the power to electro pneumatic valve actuator (for controlling the tyre air pressure according to the trigger from ITTMV). The ITTMV tap the required power for its operation according to vehicle's running conditions and engine parameters (Example—vehicle running down the slope or declined roads with excess speeds where the cruise control system controls the excess speed to maintain pre-set speed).

The ITTMV 102 comprise of sensor system that works based on one or combination of sensors, safety & stability parameters, configurations, operating modes and usage scenarios for detecting the critical situations of vehicles experiencing or moving beyond the limits of vehicles available safety and stability systems with sensors for active sensing and utilise it for pre-computing & set ready to control tyre pressure, current-computing to control the tyre pressure during critical situation and post-computing to control the tyre pressure after critical situation ultimately to overcome and mitigate the critical situations—1. Sensors for sensor systems comprise of Pressure sensors, Temperature sensors, humidity and moisture sensors for sensing the pressure, temperature, humidity and moisture content of fluids or fillers available in tyres and reservoirs. The sensor system in addition senses the external or environment's temperature, moisture and humidity for computation thereby enhancing the precision of ITTMV; 2. Vehicle speed and wheel speed sensor for sensing the vehicle speed and wheels speed thereby sensing the loss of traction and wheel slip or spin ultimately for computing the tyre pressure accordingly in critical situations; 3. Orientation sensors and accelerometer for sensing the vehicles orientation, acceleration and deceleration ultimately for computing the tyre pressure accordingly in critical situations; 4. Load sensor for sensing the load of the vehicle, load on individual wheel tyres and change in centre of gravity ultimately for computing the tyre pressure accordingly in critical situations; 5. Steering angle or position sensor for sensing the position of the steering wheel and vehicles relative motion thereby sensing vehicle stability, over and under steering ultimately for computing the tyre pressure accordingly in critical situations; 6. Brake force sensor for sensing the nature of the brake force during braking scenarios ultimately for pre-computing, current-computing and post-computing thereby to control the tyre pressure accordingly in critical situations in critical situations; 7. Sensors for sensing tyre properties and foreign objects stuck in tire, dimension & depth of penetration, tyres wear & tear, tyres cuts, bulges, sidewall damages, slow puncture with corresponding tyres location & position comprise of distance or range sensors, visual cameras, IR cameras, acoustic or ultrasonic sensor, electromagnetic sensors, electrostatic sensors, inductive sensors, capacitive sensors, echo sensors, thermal sensors. ITTMV utilise one or more optimally located internal and external sensors or sensor arrays on tyres and vehicle for scanning comprising of distance or range sensors, visual cameras, IR cameras, acoustic or ultrasonic sensor, electromagnetic sensors, electrostatic sensors, inductive sensors, capacitive sensors, echo sensors, thermal sensors for scanning & detecting tyres parameters comprising of change in tyre properties (nature), patterns, direction, dimension, positions, multi layers & range, pressure, temperature, moisture and humidity. The sensor sensing the nature or property of tyre and foreign object comprises permittivity-ε, permeability-μ, conductivity-σ, susceptibility, dielectric, capacitive sensing, capacitive displacement sensing, inductive sensing; 8. Radar and range sensors for scanning the environment around the vehicle by detecting vehicles, pedestrians and objects in front, rear and around the vehicle with its direction, dimension, nature, approaching & departing speed with respect the vehicle thereby utilised for pre-computing, current-computing and post-computing ultimately for controlling the tyre pressure according to critical situation. The radar system comprises visual, active and passive infrared cameras with real-time digital image and signal processing thereby to sense the nature of the objects around the vehicle; 9. Terrain, road or contact area sensors for sensing the nature of present contact and impending road and terrain surfaces with its property comprising of normal dry roads, wet, mud & ruts, rocks, gravel, grass, snow, sand, rough, highly uneven terrain, rocky crawl and its combinations thereby computing the tyre pressure accordingly in critical situations; 10. GPS sensors for predicting the turns, curves and bends ahead of the road for pre-computing and set ready for action in controlling the tyre pressure accordingly; 11. ITTMV utilises predetermined and tested field mapping or lookup table for sensing, comparing & matching the effects between real time sensor system parameters with predetermined and tested sensor system parameters ultimately for computing the tyre pressure accordingly; 12. The sensor systems precision levels, sensing depth of dimension and multi-layer sensing are utilised depending upon the design & requirement. The sensor system utilise sensors, with either fixed or tuneable sensitivity and the range are selected according to design, scenarios and requirement.

The ITTMV 102 system utilise correlation or lookup tables to actively check and compare the effects caused in actual real world scenarios with predetermined and tested real world scenarios to control and modulate the tyre pressure accordingly in critical situations. The tables comprise of pressure values that lies between upper and lower cut-off tyre pressure values designed and developed with corresponding change in vehicles load and centre of gravity thereby the ITTMV 102 system controls the tyre pressure between upper and lower cut-off tyre pressure values according to scenarios to mitigate critical situations while preventing the over inflation and deflation or tyre deformation ultimately to sustain stability. The table is designed and developed based on ITTMV designs, scenarios, configurations and parameters comprising of—sensor system, vehicle stability & safety systems, nature of braking & brake force, tyres lower & upper cut-off threshold pressure values, sensing reservoirs and tyres internal & external or environmental—pressure, temperature, moisture, humidity, vehicles speed, wheel speed, acceleration & deceleration, orientations & axial rotation (yaw, pitch and roll), load distribution (load on each wheel tire), torque distribution, vehicles suspension & vertical dynamics, transverse motion & lateral acceleration, tyre traction, slip and slide angle, steering wheel position, cornering effects, change in centre of gravity, over & under steering, aqua or hydroplaning, rim or wheel specifications, wheel alignment & balancing, tyre specifications & parameters comprising of—size, type, load index, speed symbol or rating, thread wear & tear, traction & temperature rating, compound & material used, maximum load rating, maximum permissible inflation pressure, direction, dimension, patterns of treads, lugs, voids, sipes & groves, tyres position or angle of attack, Coefficient of Friction (COF), radars detecting objects with pre-computing & current-computing of tyre pressure to assist in emergency braking & stability based on range, direction and dimension of objects in and around the vehicle, sensing nature of tyres present & impending contact area, GPS information to predict the turns, curves and bends on roads ahead and inter operating with vehicles existing stability & safety systems comprising of—ABS, EBD, ESC, TCS, Roll over mitigation systems, ECU, BA, Pre-crash systems, suspension system, vertical dynamics & damping force, Sway or anti-roll or stabilizer bar, radar assisted auto braking with partially & complete brake to stop, Drivers reaction with evasion (evasive manoeuvre) of objects, automotive aerodynamics & airbrakes, Pre-crash systems, Cruise or Adaptive Cruise Control with partial & full auto braking. As various parameters and multiple critical situations are simultaneously taken into account by ITTMV for computation, the table is designed and developed based on prioritising and balancing between one or more parameters and scenarios ultimately to achieve an optimized performance.

The TPMU valve controllers are highly time sensitive and work at high speed to control the tire pressure according to modulating signals from ITTMV. The TPMU valve controller either uses one or more combinations or is not limited to linear or nonlinear control mechanisms to control the tire pressure. The TPMU valve controller either use one or more or combinations and not limited to solenoid and motor mechanism to control the valve in turn to control the tire pressure. The TPMU valve controller utilises either one or more or combinations of but not limited to direct linear motor or ball screw mechanisms. The valve controller comprises circuitry and power source to control the tire pressure on very high speed. The TPMU controller's actuators capacity regarding torque/force required to move and hold the valve core, voltage, armature/valve core travel distance or range, speed, duty cycle, orientation, environments etcetera are all selected according to design, configured and scenarios. The TPMU valve controller utilises either one or more or combinations of but not limited to motors comprising servo, stepper motor etcetera. The TPMU and its wheel tire design comprises of either one or more or combinations of but not limited to sensor's comprising Gyro sensor, Accelerometer, compass, humidity sensor, and piezoelectric sensor all to monitor the real-time individual and relative vehicle and tire dynamics precisely for computing, controlling and optimising the contact patch area. The pizo electric sensors are laid in the tires to monitor the change in nature of deformation and mechanical forces acting on the tires to actively control the tire pressure accordingly. The TPMU power source design comprises of either one or more or combinations of but not limited to battery, capacitor, electric power converter drive, DC-DC convertor, constant power circuit drive, constant current source circuit, induction drive, cap booster drive, cap recharger drive, cap batteries drive, capacitor boost drive, super capacitor drive, Silicon-controlled rectifier or thyristor drive, PDS drive, capacitive discharge drive, inductive discharge drive, Kinetic brake energy drive etcetera. The TPMU and its wheel tire design either utilises application specific or with universal standard valve. The TPMU and its wheel tire design comprise of designs where the universal standard valve is divided into 2 parts—one part is constants where the part or portions of the valve are not modified to maintain the existing standards and compatibilities. Another is variables where the part or portions of the valve are modified to design and integrate the valve core control mechanism. The TPMU and its wheel tire design comprise of at least one or both the valve stem and valve core lengths are either maintained or lengthen or shortened to accommodate the valve core controller mechanism. The TPMU and its wheel tire design comprises of system where the controller is coupled at least from one or more or combination and not limited to top, bottom, sides, circumferentially and angularly with the valve core for controlling fluids. The TPMU and its wheel tire design comprises of system where the controller is coupled at least from one or more or combination and not limited to top, bottom, sides, circumferentially and angularly with the valve stem for controlling fluids. The TPMU and its wheel tire design comprises a system where the controller is coupled at least from one or more or combination and not limited to top, bottom, sides, circumferentially and angularly with the wheel and hub for controlling fluids. The TPMU and its wheel tire design comprise of a system where dedicated valves stem and valve controller are utilised for controlling the tire pressure. The TPMU and its wheel tire design comprises either one or more of universal standard valve or application specific valve or dedicated valve stem or its combinations are utilised in hybrid mode for controlling the tire pressure. The TPMU comprising control mechanism, power source, sensors, circuitry, RF transceivers etcetera are all integrated into hub or toward or on the centre of the wheel to reduce the centrifugal forces acting on the body and to sustain the balancing. Even to avoid using tire weights to counter the forces and to avoid the additional weight. A dedicated space in the centre of the wheel are also utilised contain the components of TPMU. According to another aspect the fluid channels is created for the outer wheel tire area to centre of the wheel for the valve to access, control and restore the tire pressure. According to another aspect the valve stem controller are located in the wheel hub. According to another aspect the components of TPMU with valve stem and valve controllers are located circumferentially or in any portion of the wheel tire and hub. According to another aspect either one or more valve and controller is utilised to control the tire pressure. According to another aspect the fluid channels is created to any desired location of the wheel for the valve to control and restore the tire pressure. According to another aspect one or more or combination but not limited to the real-time frequency, wobble, eccentric load, ride disturbances, vertical and lateral vibrations of the tire are all sensed and shared with vehicle safety and stability systems to further enhance the dynamics of the vehicle. For example but not limited to the tuning s the suspension based on the frequency, instantaneous velocity, deformation rate and nature of the tires to further enhance the dynamics and comfort of the vehicle. According to another aspect the present system senses the frequency of change in tire pressure in real time when the vehicle is in motion to control the tire pressure. According to another aspect of the present system, one or more or combination but not limited to rotary unions are utilised in wheel tires, hub and axel to isolate the stationary and rotary components of the controllers.

With self-supporting reinforced tyres the efficiency of ITTMV is further enhanced where these tyres have an additional supporting ring attached to the wheel that can support the weight of the vehicle in the event of a loss of pressure. For Example—Run-flat tyres (RFT) have specially reinforced sidewalls and additional lateral strengthening helps continue to perform their function even if all air pressure is lost. The heat-resistant rubber compounds are able to withstand additional heat build-up and the wheel rims of run-flat tyres have special design that ensures the tyre will not detach from the rim, even on tight bends. The ITTMV also assists in reducing the braking or stopping distance of aircrafts—landing or take-off on runway in critical situations like abort take-off, rejected take-off due to over running of runway for take-off, emergency landing, reducing stopping distance in brake failure etcetera which can sometimes leads to aircraft moving beyond safety margin and the available runway may be insufficient to stop the aircraft. The wheel tyres with TPMU are constructed with a counterweight or utilise externally added tyre weights (balance) to compensate for the mass of the TPMU. The precisely well-equipped ITTMV helps in mitigating the negative effects caused by vehicles utilising mixed tyres like old & new tires, different tread pattern tyres and different types like wet & dry tyres, Soft & hard compound tyres, slick & intermediate tires, summer & winter tyres with various patterns off treads, lugs, voids, grooves etcetera thereby by ultimately enhancing the overall performance.

Insulated Electro Fluidic Rotary Joint to Transfer Power and Data to Wheels—Electrically Insulated Multiple Individual Container/Channel Rotary Union with Independent Electrically Insulated Container/Channels Filled with Electrically Conductive Fluids Container and Pin Contactor Headers to Transmit Hybrid Power and Data. Electro Fluidic Rotary Union to transmit power and data from a stationary to a rotating structure. The insulated channel may comprise an inside conductive layer to further enhance connectivity. Insulated Electro Fluidic Rotary Joint to Transfer Power and Data to Wheels comprises following components—1. Wheel Hub and Bearing Assembly, 2. Housing, 3. Outer insulation layer for isolating the fluid container from the housing, 4. Rotary Seals Ring to Isolate Conductive Fluid, 5. Conductive Grease, 6. Stator Conductor, 7. Rotor Conductor, 8. Conductive fluid/grease gap that conducts electricity and date between stator conductor and rotor conductor, 9. Axel, 10. Inner Wheel Bearing, 11. Inner Bearing Seal, 12. Outer Wheel Bearing, 13. Outer Bearing Seal, 14. Castellated Nut, 15. Wheel Rotor, 16. Wheel Studs, 17. Power and Data Pin Connector and 18. Wheel comprising of jack to connect the wheel hub pin.

Disk brake rotor may comprise holes to make electrical connection between pin contactors of wheel hub and wheel's jack. Wheels may comprising of studs pin and jack contactor mechanism that make use of disk brake rotor holes to couple and connect while mounting wheels thereby to receive power and exchange data from wheel hub and vehicle. Wheel hub bearing assembly and steering knuckle housing may comprises of automatic self-sealing Schrader valve connected to each channel to fill, top up and completely replace electrically conductive fluids/grease. May comprise one or more Electrically Insulated Individual Channel where one channel is utilised for high voltage another one channel utilised for low voltage, another one channel for data. may use at least one fluid channel that connects the wheels to Central Active Pneumatic Control Unit's [CAPCU] high pressure reservoir/compressor that feed's fluids like air/nitrogen through fluid channels where each channel comprise of a dedicated real-time pneumatic modulator valve to instantaneously modulate and optimize tire pressure according to time sensitive critical situations. This fluid channel may either connect to wheel's high pressure reservoir or may directly connect to tires to directly or indirectly optimize and modulate instantaneous tire pressure according to time sensitive critical situations. May use at least one fluid control channel that connects the wheels to Central Active Pneumatic Control Unit's [CAPCU] to wheel tires as a return or feedback channel. The central high pressure reservoir/compressor may comprise of an active pneumatic control unit with dedicated real-time modulator valve for each fluid channel to optimize and modulate instantaneous tire pressure according to time sensitive critical situations.

The embodiments of the ITTMV is not limited to listed scenarios described here or its combinations and the above presented are just examples. There may be other scenarios and those who are skilled in the field can understand and modify, enhance, alter the herein system without departing from the scope of the invention in its widest form.

1. A Instantaneous Tire Traction Modulating Valves [ITTMV] is a time sensitive fail-safe electro pneumatic valve design, valve's current profile and regulator technique to proactively sense and instantaneously modulate the tire pressure between tire's upper and lower cut-off pressure values from the present/recommended value thereby instantaneously modulating right tire pressure on right time on right tires of vehicles tyres thereby instantly optimizing footprint/sidewall deformation and provide enhanced traction to overcome critical situations all without compromising safety, stability and steer-ability and restore/optimize to pre-set tyre pressure value immediately after overcoming critical situation for further safe and comfortable driving.
a) a sensor system with that defect's both active and passive parameters encompassing real-time monitoring, sensing and generating trigger signal by detecting the vehicle's critical situations comprising:
hydroplaning or aquaplaning;
loss of stability;
over and under steering;
loss of traction;
high speed and emergency braking;
rollover;
puncture;
road surface nature and property,
wheel tire's NVH [Noise, Vibration and Harshness];
Vehicle's RADAR, LIDAR and CAMERA;
climatic conditions;
Vehicle to Vehicle [V2V] data and Vehicle to Infrastructure [V2I] data;
b) a processing unit that actively sense, process and generate tire pressure modulating signal by instantaneously sensing, pre-computing and set ready to optimize the tire pressure prior to critical situation, current-computing to modulate the tire pressure to during critical situation, post-computing to immediately restore or optimize tire pressure after overcoming the critical situations and to continue with comfortable driving;
c) a Tire Pressure Modulating Units (TPMU) that instantaneously acts according to the modulating signal from the processing unit is located on each wheel tire to actively modulate, optimize and restore the tire pressure in right time with right pressure on right tires thereby instantaneously optimizing the tire's contact patch area and sidewall deformation rate to enhance traction and stability while sustaining vehicle's drivability or steer-ability thereby to overcome or mitigate the critical situations to protect occupants, vehicles, pedestrians and other things around the vehicle where the applications comprising of
mitigating hydroplaning;
mitigating loss of stability and control;
mitigating over and under steering;
mitigating loss of traction;
minimising emergency and high speed braking distance;
mitigating roll over;
mitigating loss of control due to puncture;
f) the TPMU comprises of at least one fail-safe external electro pneumatic modulating valve with actuators that connects the tire and atmosphere for externally modulate and refilling the tire pressure, at least one fail-safe internal electro pneumatic valve with actuators that connects the high pressure reservoir and the tire for internally modulate and refilling the tire pressure and at least one external non electro pneumatic valve for connecting and refilling high pressure reservoir; when the solenoid coil is energized the armature connected with governor is actuated thereby instantaneously opening the valve stem for optimizing the tire pressure and when the solenoid is de-energized through fast decay and the spring mechanism restores the position of the governor valve thereby closing the valve stem opening;
e) a wheel integrated with high pressure reservoirs;
g) the ITTMV optimize the pressure by releasing the fillers such as air or nitrogen to atmosphere while maintaining the tire's lower cut off threshold pressure value where the pneumatic valve automatically closes when lower cut off tire pressure value is reached which is above the minimum tire pressure value to sustain stability/steer-ability and instantaneously optimize the pressure on all tires for further safe driving till next gas station or filling until restoration or else instantaneously restores the pressure to optimum pre-set value utilizing inbuilt reservoir or external restoration system immediately after the vehicle overcomes critical situation to continue with comfortable driving.
h) a control—high/low volt drive circuitry for monitoring and instantaneously operate valve's according to tire pressure modulating signal from processing unit comprising Sources/timing, DCDC Boost Converter, valve drive circuit and ITTMV's electro pneumatic valve coil;
i) the high and low voltage drive circuitry is used where valve's Opening Phase Time [OPT] utilises high boosted voltage across the coil to achieve steep current profile/rapidly increase current through the coil which in turn reduces opening time, instantaneously open the valve, followed by utilisation of low voltage in Hold Phase Time [HPT] to hold the opened valve to modulate the fluid flow and followed by Closing Phase Time [CPT] where current through the coli is quenched to rapidly reduce the valve's closing time in close phase.
j) a power source comprising of batteries, capacitors, external power supply or hybrid combination of all for providing both low and high volt accordingly for instantaneous valve operations;
k) a radio frequency transceivers and antennas for wireless communication;
l) a Rotary-link comprising Electrically Insulated Conductive Fluidic Containers to Transfer Power and Data to Wheels [REICFCTPDW] is integrated in wheel and hub housing for valve's monitoring and operations where electrically insulated multiple individual containers in rotary link comprising independent electrically insulated container filled with electrically conductive fluids/grease and pin contactor headers to transmit power and data from stationary to rotating structure wheel's; the rotary link may use at least one fluidic channel to transfer fluids from vehicle to wheel tire;
m) the ITTMV utilise smart and adaptive closed loop processing algorithm with correlation or lookup table to instantaneously check and compare the effects between predetermined and tested real world scenarios and parameters to the actual real world scenarios for smart and actively—sensing, computing and optimizing the tyre pressure accordingly to mitigate the critical situations;
n) The ITPMVCS uses sensors in TPMU comprising of microphone, accelerometer, intensity probe, laser vibrometer, force gauge or load cell to sense the live nature of contact patch area, its NVH (Noise, Vibration and Harshness), process and detect critical situation thereby accordingly and instantaneously optimize tire pressure.

2. The ITTMV said in claim 1, comprise of sensor system that works based on one or combination of sensors, safety and stability parameters, configurations, operating modes and usage scenarios for detecting the critical situations of vehicles experiencing or moving beyond the limits of vehicles available safety and stability systems comprising:
a) pressure sensors, temperature sensors, humidity and moisture sensors for sensing the pressure, temperature, humidity and moisture content of fluids or fillers available in tyres and reservoirs respectively; the sensor system also senses the external or environments temperature, moisture and humidity for computation thereby to enhance the precision of the ITTMV;
b) vehicle speed and wheel speed sensor;
c) orientation sensors and accelerometer for sensing the vehicles orientation, acceleration and deceleration;
d) load sensor for sensing the load of the vehicle, load on individual wheel tyres and change in centre of gravity;
e) microphone, accelerometer, intensity probe, laser vibrometer, force gauge or load cell to sense the live nature of contact patch area, its NVH (Noise, Vibration and Harshness),
f) steering angle or position sensor for sensing the position of the steering wheel and vehicles relative motion thereby sensing vehicle stability, over and under steering;
g) brake force sensor;
h) radar and range sensors for scanning the environment around the vehicle by detecting vehicles, pedestrians and objects in front, rear and around the vehicle with its direction, dimension, distance, nature, approaching and departing speed with respect to the vehicle; the radar system comprises of visual, active and passive infrared cameras with real time digital image and signal processing thereby to sense the nature of the objects around the vehicle;
i) terrain, road or contact area sensors for sensing the nature of present contact and impending road and terrain surfaces with its property comprising of normal dry roads, wet, mud and ruts, rocks, gravel, grass, snow, sand, rough, highly uneven terrain, rocky crawl and its combinations;
j) GPS, location and positioning sensors for predicting the turns, curves and bends ahead of the road.
k) microphone, accelerometer, intensity probe, laser vibrometer, force gauge or load cell to sense the live nature of contact patch area, its NVH (Noise, Vibration and Harshness),

3. The ITTMV also inter operate with vehicles ECU's and existing stability and safety systems comprising:
Anti-lock Braking System (ABS);
Electronic Brake-force Distribution (EBD);
Electronic Stability Control (ESC);
Traction Control System (TCS);
Roll over mitigation systems;
Engine Control Unit (ECU);
Brake Assist (BA);
Pre-crash systems;
suspension system;
vertical dynamics and damping force;
sway or anti roll or stabilizer bar;
radar assisted auto braking with partially and complete brake to stop;
automotive aerodynamics and airbrakes;
sensing drivers reaction with evasion manoeuvre of objects; and
Cruise or Adaptive Cruise Control with partial and full auto braking thereby instantaneously directing the TPMU to modulate the tyre pressure on corresponding tyres in right time to overcome or mitigate the critical situations; as various parameters and multiple critical situations are simultaneously taken into account by ITTMV for computation, the ITTMV's algorithm smartly sense, prioritise and balance between one or more parameters and scenarios to achieve the optimized solution.

4. The ITTMV said in claim 1, where the TPMU is located in each wheel tire, hub and axel comprising:
a) the TPMU utilise fail-safe and fail-proof electro pneumatic valves system with actuators for modulate the tyre pressure according to modulating signal from ITTMV; the TPMU comprise of and utilise wheel tyres integrated with single to multiple internal and external, unidirectional and bidirectional, valves with and without actuators, normally open and normally closed valves, basic and electro pneumatic valves, dedicated and common valves for storing, modulating, optimizing and restoring the tyre pressure according to design, configurations and scenarios;
b) power source;
c) controller circuitry to modulate tyre pressure according to modulating signal from ITTMV;
d) the TPMU comprising of sensor system that collects and shares the real time information and parameters such as tyre pressure, temperature, humidity, moisture, NVH, power source status, reservoir status with ITTMV and act according to modulating signal from ITTMV thereby to instantaneously modulate the tyre pressure;
e) the TPMU utilise wireless transceiver with antenna, wired communication and its combinations for communicating with ITTMV;
f) the TPMU comprise of internal power source, external power source and its combinations for its operation and are selected from TPMU's inbuilt batteries, capacitors and vehicle batteries; the power source is wired or wireless or its combinations and the charging sources for the TPMU's inbuilt battery and capacitor are sourced from vehicle battery, external charging systems, internal self-charging systems with feasible alternator or generator, capacitive coupling, inductive coupling, electromagnetic coupling and regenerative brakes; the type of batteries utilised comprise of primary batteries, rechargeable batteries and its combinations;
g) the power source is either external, internal fixed or replaceable and its combinations with the TPMU smartly managing the charging and backup of the power levels with updating and alerting the status of power source to ITTMV, display and user interface;
h) the TPMU may work with and without, internal and external reservoir or its combinations for instantaneously modulating and optimizing the tyre pressure during and after overcoming the critical situations; in critical situations the TPMU modulate the tyre pressure by either releasing the fillers to atmosphere and restore from internal and external reservoir store and restore the fillers from and to internal and external reservoir according to design, configurations and scenarios;
i) the TPMU comprising reservoir works to instantaneously optimize the tyre pressure during and after overcoming the critical situations utilising the high pressure fillers in the reservoir; the TPMU comprise of modulating system with internal pneumatic valve that connects the reservoir with tyre internally for modulating the tyre pressure and external valve for modulating as well as recharging the fillers;
j) the TPMU utilise either common or dedicated valves for optimizing the tyre pressure as well as restoring the fillers; the modulating valves are selected from pneumatic valves, electro pneumatic valves, mechanical valves, electro mechanical valves and its combinations;
k) each TPMU is represented by unique identification with which the ITTMV identifies and communicate with accordingly; the ITTMV also accounts the replacement of tyres to precisely track the change of tyres in scenarios of puncture, wear and tear thereby to control the TPMU accordingly;
l) the ITTMV also optimizes the tyre pressure on the spare tyre to match with other tyres in case of tyre changed according to scenarios;
m) the TPMU instantaneously modulate the tyre pressure in critical situations by transferring the fillers either from and to atmosphere else with inbuilt or external restoration systems or its combinations;
n) the TPMU utilise feasible internal or external reservoir or its combination for optimizing the fillers thereby instantaneously modulating the tyre pressure in critical situations;
o) the TPMU sense and prevents the over inflation of tyres by releasing excess fillers thereby to maintain the set and optimum pressure according to modulating signal from ITTMV;
p) the wheels with TPMU are constructed with weight balanced design or with counterweight and utilise internal and externally added weights to balance or compensate for the mass of the TPMU.

5. The ITTMV said in claim 1, where physical constructional features, working and fluid flow channels of the fail-safe electro pneumatic valve comprises of
a) Electro Pneumatic Valve Core—electro pneumatic valve core is coupled with solenoid actuated system and are utilised by the ITTMV system for actively opening and closing the valve during critical situations;
b) Power Source for controlling and operating ITTMV;
d) Communication System for its signalling and operation;
c) Circuitry—control and drive circuit for modulating the electro pneumatic valve;
e) On Board Computer and Processing unit—the ITTMV actively collects the required parameters, processes and instantaneously directs the TPMU's on each wheel tire to modulate the tire pressure in critical situations.
f) sensor system
g) valve stem & valve core;
h) valve stem nut with [With Pressed in Washer];
i) rubber grommet seal;
j) wheel-mount;
k) centre Shaft;
l) plunger [Top Dead Centre and Bottom Dear Centre];
m) return spring;
n) Solenoid;
o) Armature;
p) Outlet;
q) Upper Seat & Lower Seat;
r) Upper seal Ring;
s) Lower Seal Ring;
t) Perforated Disk;
u) Release Opening;
v) Plunger [Top Dead Centre and Bottom Dear Centre];
w) Stem that connects the armature, disk & guide.

6. The ITTMV said in claim 1, utilise correlation or lookup tables to actively check and compare the effects caused in actual real world scenarios with predetermined and tested real world scenarios to modulate the tyre pressure in critical situations comprising:
a) the correlation tables comprise of pressure values that lies between upper and lower cut off tyre pressure values designed and developed with corresponding change in vehicles load and centre of gravity;
b) the correlation table is designed and developed based on ITTMV designs, scenarios, configurations and parameters comprising:
sensor system;
vehicle stability and safety systems;
nature of braking and brake force;
tyres lower and upper cut off threshold pressure values;
sensing reservoirs and tyres internal and external or environmental pressure;
temperature & moisture;
wheel tire's NVH [Noise, Vibration and Harshness];
humidity;
vehicles speed;
wheel speed;
acceleration and deceleration;
orientations and axial rotation comprising yaw, pitch and roll;
load distribution on each wheel tire;
torque distribution;
vehicles suspension and vertical dynamic;
transverse motion and lateral acceleration,
tyre traction Coefficient of Friction (COF;
slip and slide angle;
steering wheel position;
cornering effects;
change in centre of gravity;
over and under steering;
aqua or hydroplaning;
tyre specifications and parameters comprising of size, type, load index, speed symbol or rating, tread wear and tear, traction and temperature rating, compound and material used, maximum load rating, maximum permissible inflation pressure, direction, dimension, patterns of treads, lugs, voids, sipes and groves;
rim and wheel specifications;
camber angle;
wheel alignment and balancing;
tyres position or angle of attack;
radars detecting objects with pre-computing and current-computing of tyre pressure to assist in emergency braking and stability based on range, direction and dimension of objects in and around the vehicle;
sensing nature of tyres present and impending contact area;
GPS information to predict the turns, curves and bends on roads ahead;
inter operating with vehicles existing stability and safety systems comprising of Anti-lock Braking System (ABS);
Electronic Brake-force Distribution (EBD);
Electronic Stability Control (ESC);
Traction Control System (TCS);
Roll over mitigation systems;
Engine Control Unit (ECU);
Brake Assist (BA);
Pre-crash systems;
suspension system;
vertical dynamics and damping force;
sway or anti roll or stabilizer bar;
radar assisted auto braking with partially and complete brake to stop;
automotive aerodynamics and airbrakes;
sensing drivers reaction with evasion manoeuvre of objects; and
Cruise or Adaptive Cruise Control with partial and full auto braking;
c) as various parameters and multiple critical situations are simultaneously taken into account by ITTMV for computation, the table is designed and developed based on prioritising and balancing between one or more parameters and scenarios ultimately to achieve an optimized performance.

7. The TPMU said in claim 4, comprising of one or more particularly high pressure fluid reservoirs or tank for storing the fillers air and nitrogen are integrated or optimally located or mounted on wheel's rim, spoke's, hub, axle with pneumatic valves and modulating unit that modulates the tyre pressure in critical situations and optimizing or restoring the tyre pressure after overcoming the critical situations according to the modulating signal from ITTMV; the reservoir systems operates without any compressor or other similar systems as the pressure maintained in the reservoir is higher or multiple times than the optimum tyre pressure for the fluids or fillers to flow from reservoir to tyre thereby modulate the tyre pressure according to modulating signal from ITTMV.
a) the fillers in the reservoir or tank are maintained with pressure higher or multiple times higher than the upper cut off tyre pressure threshold value for the fillers to instantly flow from the reservoir to tyres and the same is utilised for modulating the tyre pressure according to modulating signal from ITTMV; the fillers in the reservoir are restorable and restored through external means similarly restored while filling the normal tyre pressure;
b) the reservoir system comprises of fail-safe pneumatic valves system with actuators and utilise single to multiple internal and external, unidirectional and bidirectional, basic and electro pneumatic valves, valves with and without actuators, normally open and normally closed valves, dedicated and common valves for storing, modulating, optimizing and restoring the tyre pressure according to design, configurations and scenarios;
c) the reservoir comprise of modulating internal pneumatic valve that connects the reservoir with tyre internally to modulate the tyre pressure and external valve to modulate as well as recharging the fillers;
d) the valve system utilise either common or dedicated valves for modulating the tyre pressure as well as restoring the fillers;
e) the modulating valves are selected from pneumatic valves, electro pneumatic valve, mechanical valve, electro mechanical valve and its combinations;
f) the reservoir system comprise of dedicated sensor system for sensing the pressure, temperature, moisture and humidity of the fillers available in the reservoir with status of the sensor system being updated to ITTMV for computation and user display or interface;
g) the ITTMV also accounts the quantity of fillers available in the reservoir with sensor system parameters for the computing, modulating and restoring the tyre pressure;
h) the ITTMV alerts the driver regarding lack of fillers and low pressure in reservoir; in scenarios of reservoir with not sufficient fillers or pressure the ITTMV alerts the driver regarding the same and works in default mode where the ITTMV won't utilise fillers in the reservoir to optimize the tyre pressure;
i) the reservoir system is optimally designed and integrated according design of wheels and are either fixed or interchangeable with the wheels;
j) modulation of tyre pressure with reservoir system is performed based on configurations comprising of releasing the fillers to atmosphere and modulating or restoring through fillers in the reservoir or else modulating through storing and restoring of fillers from and to reservoir according to design and scenarios;

8. The ITTMV said in claim 1, works in critical situation with following configurations comprising of one or more combinations with reservoir and compressor systems:
a) the ITTMV works in critical situations with reservoir by utilising the high pressure fillers in the reservoir to modulate the tyre pressure; where the fillers in the reservoir have to be restored from external sources;
b) the ITTMV works in critical situations with appropriate compressor systems available with vehicles existing inflation systems in critical situations.

9. The ITTMV said in claim 1, comprise of one or more or combination of but not limited to internal and external, fixed or replaceable power source for ITTMV and TPMU's operation are selected from TPMU's inbuilt batteries, primary or rechargeable batteries, capacitors and vehicle batteries according to design, configurations and scenarios.
a) the power source is wired or wireless or its combinations and the charging sources for the TPMU's inbuilt battery and capacitor are sourced from vehicle battery, external charging systems, internal self-charging systems with feasible alternator or generator, piezoelectric effect, capacitive coupling, inductive coupling, electromagnetic coupling, kinetic brake energy;
b) the ITTMV smartly manages the charging and backup for instance under and over charging protection of the power levels with updating and alerting the status of power source to ITTMV, display and user interface;
c) the TPMU tap's the required power for its operation from and based on vehicle's running conditions and engine parameters for instance vehicle running down the slope or declined roads with excess speeds where the cruise control system controls the excess speed to maintain pre-set speed.

10. The ITTMV said in claim 1, Insulated electro fluidic rotary joint to transfer power and data to wheels, electrically insulated multiple individual container/channel rotary link with independent electrically insulated container/channels filled with electrically conductive fluids container and pin contactor headers to transmit power and data. Electro Fluidic Rotary link to transmit power and. Insulated Electro Fluidic Rotary Link to Transfer power and data from a stationary to a rotating structure and vice versa that is from wheel hub to wheel comprises of following components
a) the wheel hub bearing assembly may comprise of at least one or more externally electrically insulated fluid container to provide isolation from housing and pin contactor headers to transmit power and exchange date from wheels to wheel hub and vehicle;
b) Outer insulation layer for isolating the fluid container from the housing;
c) Rotary Seals Ring to Isolate Conductive Fluid;
d) Electrically Conductive Fluid/Grease;
e) Stator Conductor;
f) Rotor Conductor;
g) Conductive fluid/grease gap that conducts electricity and date between stator conductor and rotor conductor;
h) Axel;
i) Inner Wheel Bearing;
j) Inner Bearing Seal;
k) Outer Wheel Bearing;
l) Outer Bearing Seal;
m) Castellated Nut;
n) Wheel Rotor;
o) Wheel Studs;
p) Power and Data Pin Connector;
q) at least one or more seals to isolate conductive fluid container;
r) fluid container may have inside conductive layer holding the conductive fluid to increase conductivity;
s) rest of the wheel hub body act as a ground;
t) Disk brake rotor may comprise of holes to make electrical connection between pin contactors of wheel hub and wheels;
u) Wheels may comprising of studs pin and jack contactor mechanism that make use of disk brake rotor holes to couple and connect while mounting wheels thereby to receive power and exchange data from wheel hub and vehicle;
v) wheel hub bearing assembly and steering knuckle housing may comprises of automatic self-sealing Schrader valve connected to each channel to fill, top up and completely replace electrically conductive fluids/grease;
w) may comprises of one or more Electrically Insulated Individual Channel where one channel is utilised for high voltage another one channel utilised for low voltage, another one channel for data;
x) may use at least one fluid channel that connects the wheels to Central Active Pneumatic Modulating Unit's [CAPMU] high pressure reservoir/compressor that feed's fluids like air/nitrogen through fluid channels where each channel comprise of a dedicated real-time pneumatic modulator valve to instantaneously modulate and optimize tire pressure according to time sensitive critical situations;
y) this fluid channel may either connect to the wheel's high pressure reservoir or may directly connect to tires to directly or indirectly optimize and modulate instantaneous tire pressure according to time sensitive critical situations. May use at least one fluid control channel that connects the wheels to Central Active Pneumatic Modulating Unit's [CAPMU] to wheel tires as a return or feedback channel;
z) The central high pressure reservoir/compressor may consist of the active pneumatic modulating unit with dedicated real-time modulator valve for each fluid channel to optimize and modulate instantaneous tire pressure according to time sensitive critical situations.
